(19) United States
(12) Patent Application Publication
(10) Pub. No.: US 2026/0282133 A1
(43) Pub. Date: Sep. 17, 2026

(54) NON-PRIMARY CHANNEL ACCESS WITH LINK MANAGEMENT MECHANISM IN WIRELESS COMMUNICATIONS

(71) Applicant: MEDIATEK INC., Hsinchu City (TW)

(72) Inventors: Kai Ying LU, San Jose, CA (US); Kuo-Wei CHEN, Hsinchu City (TW); Cheng-Yi CHANG, Hsinchu City (TW); Chien-Fang HSU, Hsinchu City (TW); James Chih-Shi YEE, San Jose, CA (US); Hung-Tao HSIEH, Hsinchu City (TW)

(21) Appl. No.: 19/168,285

(22) PCT Filed: Nov. 13, 2024
(86) PCT No.: PCT/CN2024/131692

§ 371 Date: Sep. 23, 2025

Related U.S. Application Data
(60) Provisional application No. 63/598,565, filed on Nov. 14, 2023.

(51) Int. Cl. H04W 76/15; H04W 74/0808; H04W 84/12

(52) U.S. Cl. CPC H04W 76/15; H04W 74/0808; H04W 84/12

(57) ABSTRACT

Techniques pertaining to non-primary channel access with a link management mechanism in wireless communications are described. An apparatus (e.g., access point (AP)) establishes a basic service set (BSS) with an operating bandwidth over a primary link. The apparatus switches to an auxiliary link responsive to detecting an overlapping basic service set (OBSS) transmission on the operating bandwidth of the primary link. The apparatus then performs a frame exchange with one or more non-AP stations (STAs) over the auxiliary link.

### CROSS REFERENCE TO RELATED PATENT APPLICATION

The present disclosure is part of a non-provisional patent application claiming the priority benefit of U.S. Provisional Patent Application No. 63/598,565, filed 14 Nov. 2023, the content of which herein is incorporated by reference in its entirety.

### TECHNICAL FIELD

The present disclosure is generally related to wireless communications and, more particularly, to non-primary channel access with a link management mechanism in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) and wireless local area networks (WLANs) under the Institute of Electrical and Electronics Engineers (IEEE) 802.11 standards, the next-generation system supports operations in wider bandwidths such as 80 MHz, 160 MHz and 320 MHz, and non-primary channel may be used for performing channel access when an overlapping basic service set (OBSS) transmission is detected on a primary 20 MHz channel. The non-primary channel access is mainly discussed within the bandwidth of the basic service set (BSS). However, if an OBSS transmission is detected on the primary 20 MHz channel, the entire 80 MHz channel may be also occupied since most of current devices support an 80 MHz bandwidth. When an access point (AP) sets up a BSS with a smaller operating bandwidth such as 80 MHz, it may not be able to use a non-primary channel access scheme to obtain a transmission opportunity (TXOP) on the non-primary channel because the entire operating bandwidth may be occupied by the OBSS transmission. Thus, how to enable non-primary channel access to allow operations on non-primary channel(s) outside the operating bandwidth remains a challenge. Therefore, there is a need for a solution for non-primary channel access with a link management mechanism in wireless communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods, and apparatuses pertaining to non-primary channel access with a link management mechanism in wireless communications. It is believed that implementation of one or more schemes proposed herein may address or otherwise alleviate the aforementioned issue(s).

In one aspect, a method may involve an access point (AP) establishing a BSS with an operating bandwidth over a primary link. The method may also involve the AP switching to an auxiliary link responsive to detecting an OBSS transmission on the operating bandwidth of the primary link. The method may further involve the AP performing a frame exchange with one or more non-AP stations (STAs) over the auxiliary link.

In another aspect, a method may involve a non-AP STA receiving a beacon frame or management frame from an AP over a primary link. The method may also involve the non-AP STA identifying an auxiliary link and an auxiliary link operation capability of the AP. The method may further involve the non-AP STA switching to the auxiliary link to perform a frame exchange with the AP responsive to the identifying responsive to detecting an overlapping basic service set (OBSS) transmission on an operating bandwidth of the AP on the primary link.

It is noteworthy that, although the description provided herein may be in the context of certain radio access technologies, networks and network topologies such as Wi-Fi/WiFi, the proposed concepts, schemes and any variation(s)/derivative(s) thereof may be implemented in, for and by other types of radio access technologies, networks and network topologies such as, for example and without limitation, Bluetooth, ZigBee, 5th Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario under a proposed scheme in accordance with the present disclosure.

FIG. 3 is a diagram of an example design under a proposed scheme in accordance with the present disclosure.

FIG. 4 is a diagram of an example scenario under a proposed scheme in accordance with the present disclosure.

FIG. 5 is a block diagram of an example communication system under a proposed scheme in accordance with the present disclosure.

FIG. 6 is a flowchart of an example process under a proposed scheme in accordance with the present disclosure.

FIG. 7 is a flowchart of a second example process under a proposed scheme in accordance with the present disclosure.

### DETAILED DESCRIPTION

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that the description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to non-primary channel access with a link management mechanism in wireless communications. According to the present disclosure, a number of possible solutions may be implemented separately or jointly. That is, although these possible solutions may be described below separately, two or more of these possible solutions may be implemented in one combination or another. The various solutions and schemes implement the proposed schemes between APs and non-AP STAs. Accordingly, the various solutions and schemes proposed herein may address or otherwise alleviate the issues described above.

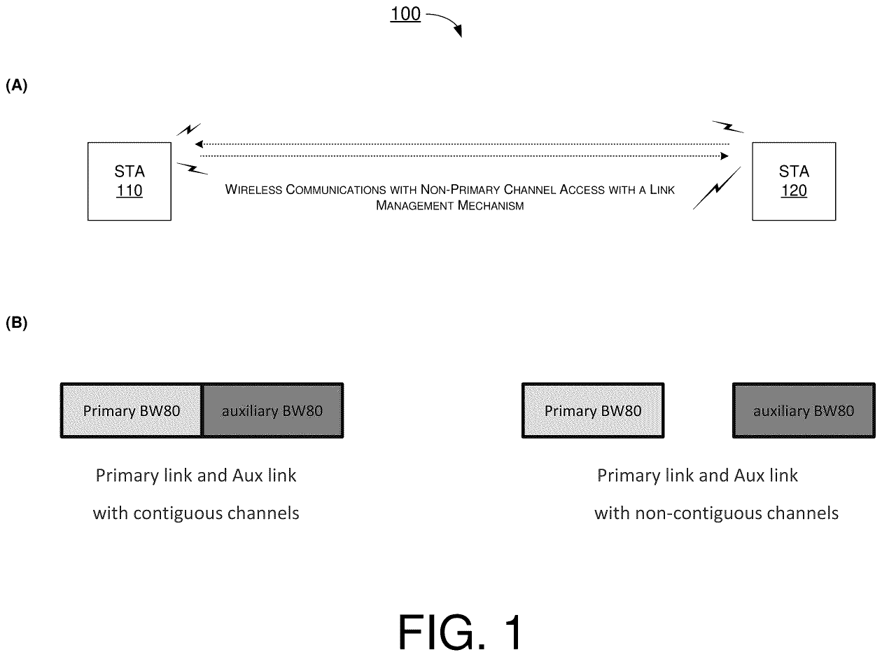

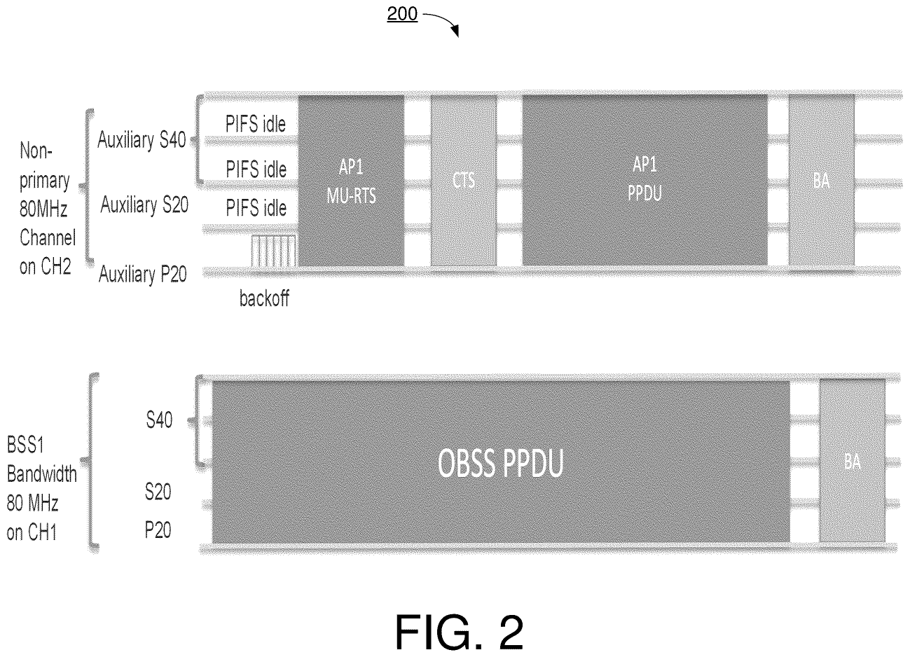

FIG. 1 illustrates an example network environment 100 in which various solutions and schemes in accordance with the present disclosure may be implemented. FIG. 2-FIG. 7 illustrate examples of implementation of various proposed schemes in network environment 100 in accordance with the present disclosure. The following description of various proposed schemes is provided with reference to FIG. 1-FIG. 7.

Referring to part (A) of FIG. 1, network environment 100 may include at least a first station (STA), or STA 110, and a second STA, or STA 120. One of STA 110 and STA 120 may be an access point (AP) STA (herein interchangeably referred to as “AP”) and the other of STA 110 and STA 120 may be a non-AP STA (herein interchangeably referred to as “STA”) associated with the AP STA. STA 110 and STA 120 may be part of a BSS. While there may be additional STAs involved in network environment 100 under one or more schemes proposed herein, for simplicity only two STAs (STA 110 and STA 120) are shown in FIG. 1 with the understanding that additional STAs may be involved. Each of STA 110 and STA 120 may be configured to implement various proposed schemes in accordance with the present disclosure as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

Referring to part (B) of FIG. 1, under the various proposed schemes, an both an AP and its associated non-AP STAs may perform channel access on a non-primary 20 MHz channel (herein interchangeably referred to as “auxiliary primary 20 MHz channel” and “auxiliary 20 MHz channel” and “auxiliary channel”) when there is an OBSS transmission detected on the operating bandwidth of the BSS. The signal level of the OBSS transmission may be over a specific threshold so that both the AP and non-AP STAs may listen or otherwise detect the same OBSS transmission. The AP or its associated non-AP STA(s) may switch from a primary link (or operating bandwidth) to an auxiliary link which includes the auxiliary primary 20 MHz channel, and the AP may perform channel access with enhanced distributed channel access (EDCA) to obtain a TXOP. The primary link and auxiliary link may occupy contiguous channels or non-contiguous channels in a frequency domain as shown in part (B) of FIG. 1.

FIG. 2 illustrates an example scenario 200 under a proposed scheme in accordance with the present disclosure. Under the proposed scheme, an AP (e.g., STA 110) may set up a BSS (e.g., BSS1) with an operating bandwidth of 80 MHz on channel 1 (CH1). In response to detecting an OBSS physical-layer protocol data unit (PPDU) transmission on its operating bandwidth, the AP may switch to channel 2 (CH2), which is idle, and perform channel access with EDCA on an auxiliary primary 20 MHz channel on CH2. The AP may obtain a TXOP after a successful frame exchange on CH2, and the TXOP obtained on CH2 may be limited by a duration of the OBSS TXOP on CH1.

Under a proposed scheme in accordance with the present disclosure, regarding advertising in an auxiliary link operation, both the primary link and auxiliary link belong to the same BSS, with the primary link and auxiliary link occupying contiguous or non-contiguous channels in the frequency domain. In an event that an AP (e.g., STA 110) is affiliated with an AP multi-link device (MLD), a link identification (ID) of each of the primary link and auxiliary link of the BSS may be the same or identical. Under the proposed scheme, the AP may transmit one or more Beacon frames and/or other Management frames (e.g., Probe response frames and/or association response frames) on the primary link, and the AP may transmit broadcast frames on the primary link. The AP may not transmit Beacon frames or other Management frames (e.g., Probe response frames and/or association response frames) on the auxiliary link, and the AP also may not transmit broadcast frames on the auxiliary link. Under the proposed scheme, the AP may advertise its capability to operate on an auxiliary link in an Ultra-High-Reliability (UHR) Operation element or UHR Capability element carried in each Beacon frame or Management frame. Additionally, the AP may advertise its auxiliary link through a Reduced Neighbor Report (RNR) element with a Target Beacon Transmission Time (TBTT) Information Field Type subfield set to one predefined value (e.g., 1) and a TBTT Information Field Length subfield set to another predefined value (e.g., 1 or 3) in a TBTT Information field corresponding to a reported AP on the auxiliary link. Notably, in this case, the reporting AP and the reported AP may be the same AP.

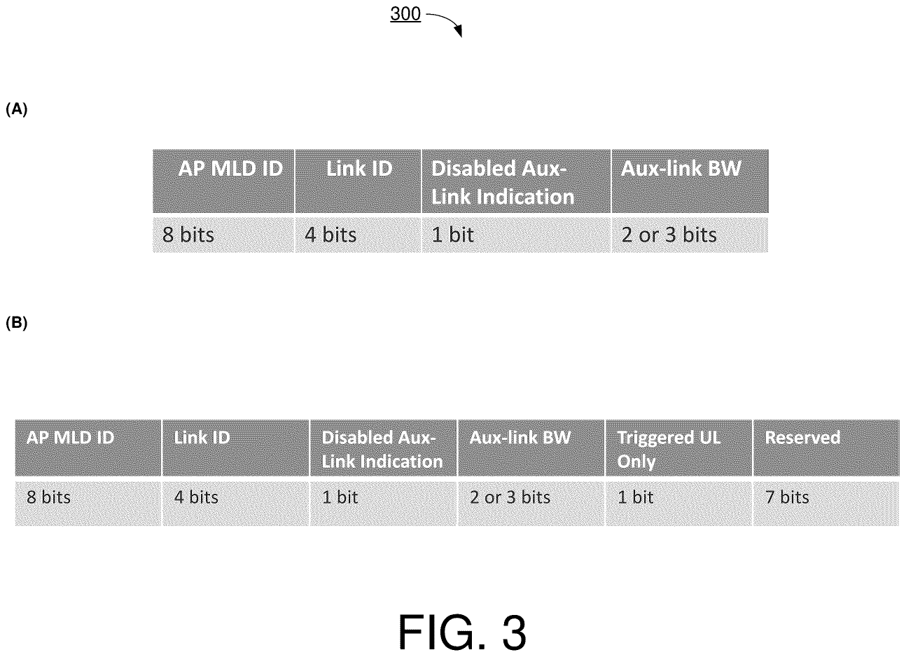

FIG. 3 illustrates an example design 300 under a proposed scheme in accordance with the present disclosure. Referring to FIG. 3, the TBTT Information field corresponding to the reported AP on the auxiliary link may include at least one of the following subfields: AP MLD ID, link ID, link disablement, Aux-link bandwidth, and Triggered UL Only. The Triggered UL Only subfield may contain a bit to indicate whether or not EDCA channel contention on the auxiliary link for associated non-AP STAs is allowed. For instance, in case that a bit in the Triggered UL Only subfield is set to a predefined value (e.g., 1), it means an uplink (UL) transmission may be trigger-based (TB) only, while no EDCA channel access is allowed. The link disablement subfield may contain a bit to indicate whether the auxiliary link is enabled or disabled. For instance, an indication of the auxiliary link being enabled may mean that the reported AP is enabled to operate on the auxiliary link, and an indication of the auxiliary link being disabled may mean that the reported AP is disabled to operate on the auxiliary link.

Under the proposed scheme, an operating class and a channel number of the auxiliary link may be indicated in a Neighbor AP field corresponding to the reported AP on the auxiliary link in the RNR element. When a reporting AP belongs to an AP MLD, the AP may advertise the primary link and auxiliary link of a neighbor AP affiliated with the same AP MLD as the reporting AP. The reporting AP may advertise the primary link of the reported AP with the TBTT Information Field Type set to one predefined value (e.g., 0) and the auxiliary link of the same reported AP with TBTT Information Field Type subfield set to another predefined value (e.g., 1) and with TBTT Information Field Length subfield set to yet another predefined value (e.g., 1 or 3) in its RNR element. An ID of the AP MLD corresponding to the primary link and auxiliary link may be set to the same or identical value. Moreover, the link ID corresponding to each of the primary link and auxiliary link may be set to the same or identical value.

Under the proposed scheme, when a reporting AP belongs to an AP MLD, the AP may include a per-STA profile sub element in a Basic Multi-Link element for the reported AP affiliated with the same AP MLD as the reporting AP. The STA Info field of the per-STA profile subelement may indicate the auxiliary link operation capability of the reported AP and the auxiliary link operating parameters (e.g., auxiliary link bandwidth, triggered UL Only indication, and so on). The STA Info field of the per-STA profile subelement may include a BSS Parameters Change Count. When there is any change related to the auxiliary link, the BSS Parameters Change Count may be incremented by 1. The STA Info field of the per-STA profile subelement may include only one Link ID which is for both the primary link and auxiliary link of this AP.

Under a proposed scheme in accordance with the present disclosure, regarding discovery and association in an auxiliary link operation, a non-AP STA (e.g., STA 120) may identify an auxiliary link operation capability of an AP (e.g., STA 110) in the UHR Operation element or UHR Capability element carried in each Beacon frame and/or Management frame transmitted by the AP. The non-AP STA may discover the auxiliary link of an auxiliary link operation capable AP by the RNR element with the TBTT Information Field Type subfield equal to 1 and TBTT Information Field length subfield equal to 1 or 3. The operating class and channel number of the auxiliary link may be determined through an Operating Class subfield and Channel Number subfield in the Neighbor AP field corresponding to the reported AP on the auxiliary link in the RNR element.

Under the proposed scheme, any non-AP STA (e.g., legacy STA or next-generation STA) may be associated with the auxiliary link operation capable AP on the primary link of the BSS without being required to support the auxiliary link operation. Additionally, a non-AP STA capable of identifying an auxiliary link may not transmit any probe request or association request frames on the auxiliary link. Moreover, a non-AP STA may indicate to the auxiliary link operation capable AP whether the non-AP STA is capable of dynamic channel switching to the auxiliary link. Also, a non-AP MLD capable of identifying an auxiliary link may not request to set up or establish a link for multi-link operation on the auxiliary link.

Furthermore, the non-AP STA may discover the auxiliary link of an auxiliary link operation capable AP by the RNR element with TBTT type subfield equal to 1 and TBTT Info length subfield equal to 1 or 3. The non-AP STA may be affiliated with a single-link, single-radio/multi-radio MLD. In an event that the non-AP STA is affiliated with a single-link device or a single-radio multi-link device, the non-AP STA may identify an auxiliary link operation capable reporting AP by the auxiliary link operation capability indicated in the UHR Operation element or UHR Capability element carried in the Beacon or Management frame. Moreover, the non-AP STA may further identify the auxiliary link disablement status and auxiliary link bandwidth of the reporting AP (which may be the same as report AP) by the RNR element.

In an event that the non-AP STA is affiliated with a multi-radio multi-link device, the non-AP STA may also identify a reported AP which is auxiliary link operation capable by the RNR element carried in the Beacon or Management frame, which may include another neighbor AP with TBTT Information Field Type subfield set to one predefined value (e.g., 1), TBTT Information Field Length subfield set to another predefined value (e.g., 1 or 3), and with the same link ID of the reported AP. The non-AP STA may further identify the link disablement status of the auxiliary link and auxiliary link operation bandwidth of the reported AP by the RNR element. Moreover, the operating class and channel number of the auxiliary link may be used to identify a primary channel of the auxiliary link of the auxiliary link operation capable AP by the Neighbor AP Information field in the RNR element.

Under the proposed scheme, a non-AP STA may indicate whether or not it supports auxiliary link operation through its UHR Operating element or UHR Capability element. Moreover, a non-AP STA may indicate its auxiliary link related operating parameters, such as bandwidth, in its UHR Operating element. The operating class and channel number of the auxiliary link may be used to identify the primary channel of the auxiliary link of the auxiliary link operation capable AP by the Neighbor AP Information field in the RNR element.

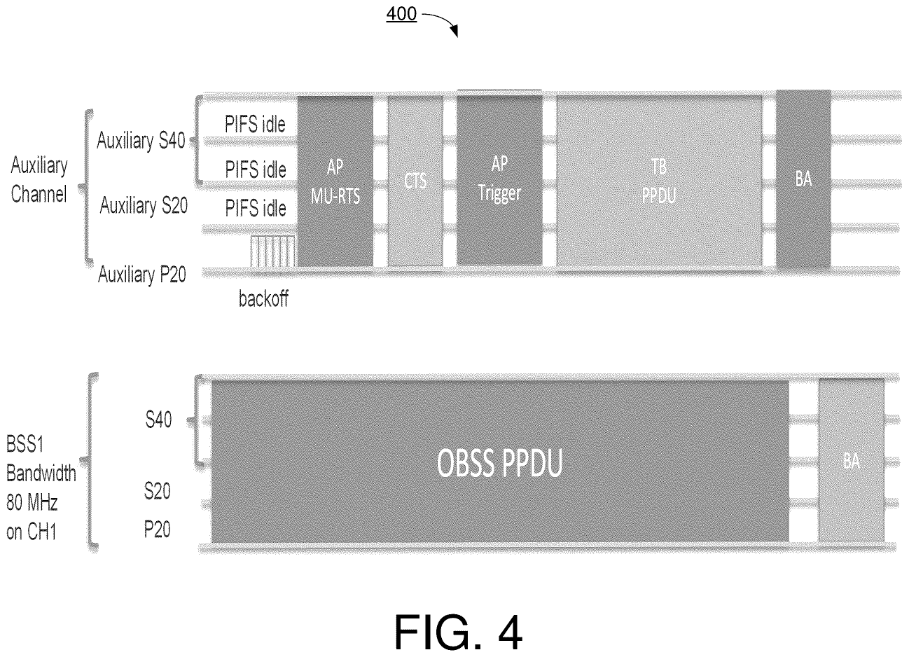

FIG. 4 illustrates an example design 400 under a proposed scheme in accordance with the present disclosure. Referring to FIG. 4, an AP (e.g., STA 110) may set up a BSS with an operating bandwidth of 80 MHz on CH1, which may be the primary link of the AP. Also, the AP may indicate its auxiliary link operation capability in its UHR Capability element or UHR Operating element. Moreover, the AP may include an RNR element to advertise its auxiliary link on CH2. Furthermore, the AP may indicate “Triggered UL Only” for the auxiliary link so that no channel contention from its associated non-AP STA(s) may be allowed.

### Illustrative Implementations

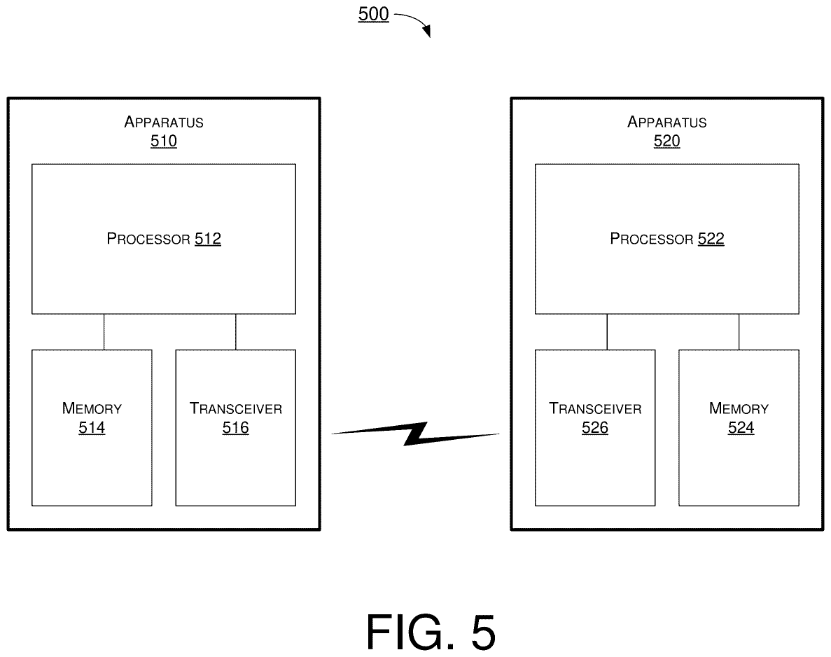

FIG. 5 illustrates an example system 500 having at least an example apparatus 510 and an example apparatus 520 in accordance with an implementation of the present disclosure. Each of apparatus 510 and apparatus 520 may perform various functions to implement schemes, techniques, processes, and methods described herein pertaining to non-primary channel access with a link management mechanism in wireless communications, including the various schemes described above with respect to various proposed designs, concepts, schemes, systems and methods described above as well as processes described below. For instance, apparatus 510 may be implemented in an AP STA (e.g., STA 110) and apparatus 520 may be implemented in a non-AP STA (e.g., STA 120), or vice versa.

Each of apparatus 510 and apparatus 520 may be a part of an electronic apparatus, such as a portable or mobile apparatus, a wearable apparatus, a wireless communication apparatus or a computing apparatus. When implemented in a STA, each of apparatus 510 and apparatus 520 may be implemented in a smartphone, a smart watch, a personal digital assistant, a digital camera, or a computing equipment such as a tablet computer, a laptop computer or a notebook computer. Each of apparatus 510 and apparatus 520 may also be a part of a machine type apparatus, which may be an IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker, or a home control center. When implemented in or as a network apparatus, apparatus 510 and/or apparatus 520 may be implemented in a network node, such as an AP in a WLAN or a mesh device.

In some implementations, each of apparatus 510 and apparatus 520 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 510 and apparatus 520 may be implemented in or as a STA or an AP. Each of apparatus 510 and apparatus 520 may include at least some of those components shown in FIG. 5 such as a processor 512 and a processor 522, respectively, for example. Each of apparatus 510 and apparatus 520 may further include one or more other components not pertinent to the proposed scheme of the present disclosure (e.g., internal power supply, display device and/or user interface device), and, thus, such component(s) of apparatus 510 and apparatus 520 are neither shown in FIG. 5 nor described below in the interest of simplicity and brevity.

In one aspect, each of processor 512 and processor 522 may be implemented in the form of one or more single-core processors, one or more multi-core processors, one or more RISC processors or one or more CISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including those pertaining to non-primary channel access with a link management mechanism in wireless communications in accordance with various implementations of the present disclosure.

In some implementations, apparatus 510 may also include a transceiver 516 coupled to processor 512. Transceiver 516 may include a transmitter capable of wirelessly transmitting and a receiver capable of wirelessly receiving data. In some implementations, apparatus 520 may also include a transceiver 526 coupled to processor 522. Transceiver 526 may include a transmitter capable of wirelessly transmitting and a receiver capable of wirelessly receiving data. It is noteworthy that, although transceiver 516 and transceiver 526 are illustrated as being external to and separate from processor 512 and processor 522, respectively, in some implementations, transceiver 516 may be an integral part of processor 512 as a system on chip (SoC) and/or transceiver 526 may be an integral part of processor 522 as a SoC.

In some implementations, apparatus 510 may further include a memory 514 coupled to processor 512 and capable of being accessed by processor 512 and storing data therein. In some implementations, apparatus 520 may further include a memory 524 coupled to processor 522 and capable of being accessed by processor 522 and storing data therein. Each of memory 514 and memory 524 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 514 and memory 524 may include a type of read-only memory (ROM) such as mask ROM, programmable ROM (PROM), erasable programmable ROM (EPROM) and/or electrically erasable programmable ROM (EEPROM). Alternatively, or additionally, each of memory 514 and memory 524 may include a type of non-volatile random-access memory (NVRAM) such as flash memory, solid-state memory, ferroelectric RAM (FeRAM), magnetoresistive RAM (MRAM) and/or phase-change memory.

Each of apparatus 510 and apparatus 520 may be a communication entity capable of communicating with each other using various proposed schemes in accordance with the present disclosure. For illustrative purposes and without limitation, a description of capabilities of apparatus 510 or apparatus 520, as an STA (e.g., STA 120) or an AP (e.g., STA 110), respectively, is provided below in the context of example processes 600 and 700. It is noteworthy that, although a detailed description of capabilities, functionalities and/or technical features of either of apparatus 510 and apparatus 520 is provided below, the same may be applied to the other of apparatus 510 and apparatus 520 although a detailed description thereof is not provided solely in the interest of brevity. It is also noteworthy that, although the example implementations described below are provided in the context of WLAN, the same may be implemented in other types of networks.

### Illustrative Processes

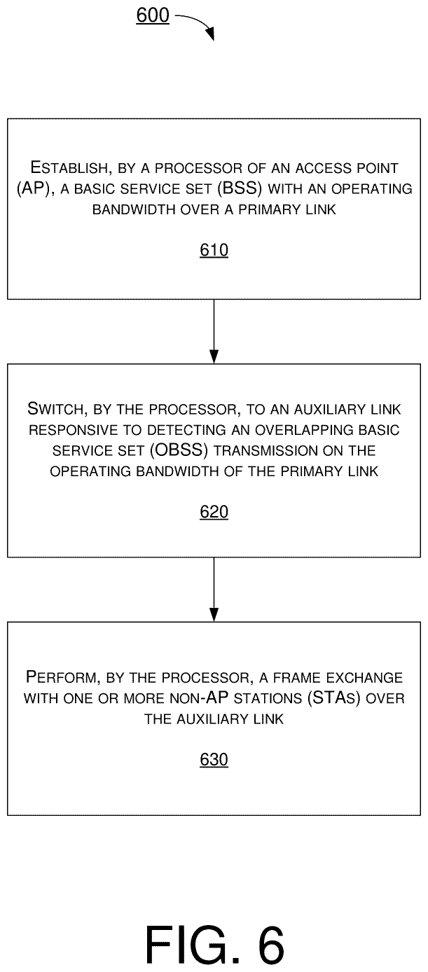

FIG. 6 illustrates an example process 600 in accordance with an implementation of the present disclosure. Process 600 may represent an aspect of implementing various proposed designs, concepts, schemes, systems, and methods described above. More specifically, process 600 may represent an aspect of the proposed concepts and schemes pertaining to non-primary channel access with a link management mechanism in wireless communications. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Furthermore, one or more of the blocks/sub-blocks of process 600 may be executed repeatedly or iteratively. Process 600 may be implemented by or in apparatus 510 and apparatus 520 as well as any variations thereof. Solely for illustrative purposes and without limiting the scope, process 600 is described below in the context of apparatus 510 implemented in or as an AP STA (e.g., STA 110) and apparatus 520 implemented in or as a non-AP STA (e.g., STA 120) of a wireless network such as a WLAN in network environment 100 in accordance with one or more of IEEE 802.11 standards. Process 600 may begin at block 610.

At 610, process 600 may involve processor 512 of apparatus 510, as an AP STA (e.g., STA 110), establishing, via transceiver 516, a BSS with an operating bandwidth over a primary link. Process 600 may proceed from 610 to 620.

At 620, process 600 may involve processor 512 switching, via transceiver 516, to an auxiliary link responsive to detecting an OBSS transmission on the operating bandwidth of the primary link. Process 600 may proceed from 620 to 630.

At 630, process 600 may involve processor 512 performing, via transceiver 516, a frame exchange with one or more non-AP STAs (e.g., including apparatus 520 as STA 120) over the auxiliary link.

In some implementations, in switching, process 600 may involve processor 512 transmitting a beacon frame or management frame on the primary link to advertise a capability of the AP to operate on the auxiliary link in an UHR Operation element or UHR Capability element carried in the beacon frame or management frame.

In some implementations, in switching, process 600 may further involve processor 512 advertising the auxiliary link through an RNR element with a TBTT Information Field Type subfield set to one predefined value (e.g., 1) and a TBTT Information Field Length subfield set to another predefined value (e.g., 1 or 3) in a TBTT Information field corresponding to the AP, as a reported AP, on the auxiliary link.

In some implementations, the TBTT Information field corresponding to the reported AP on the auxiliary link may include at least one of an AP MLD ID subfield, a link ID subfield, a link disablement subfield, an auxiliary link bandwidth subfield, and a trigger UL only subfield.

In some implementations, a value of bit in the trigger UL only subfield may indicate whether EDCA channel contention on the auxiliary link by the one or more non-AP STAs is allowed.

In some implementations, responsive to the bit in the trigger UL only subfield being set to a predefined value, an UL transmission on the auxiliary link may be trigger-based and that no EDCA channel access is allowed.

In some implementations, a value of bit in the link disablement subfield may indicate whether the auxiliary link is enabled or disabled, such that: (a) responsive to the link disablement subfield indicating the auxiliary link being enabled, the reported AP may be enabled to operate on the auxiliary link; and (b) responsive to the link disablement subfield indicating the auxiliary link being disabled, the reported AP may be disabled to operate on the auxiliary link.

In some implementations, an operating class and a channel number of the auxiliary link may be indicated in a Neighbor AP field corresponding to the reported AP on the auxiliary link in the RNR element.

In some implementations, the AP, as a reporting AP, may be affiliated with an AP MLD. In such cases, an AP MLD ID corresponding to each of the primary link and the auxiliary link may be set to a same value, and a link ID corresponding to each of the primary link and the auxiliary link may be set to another same value.

In some implementations, in switching, process 600 may further involve processor 512, acting as a reporting AP affiliated with an AP MLD, transmitting a beacon frame or management frame with a Basic Multi-Link element corresponding to the AP, as a reported AP, which is also affiliated with the AP MLD. Moreover, a STA Information field of a per-STA Profile subelement in the Basic Multi-Link element may indicate an auxiliary link operation capability of the reported AP and one or more auxiliary link operating parameters. Furthermore, the STA Information field may include a BSS Parameters Change Count which is incremented responsive to a change related to the auxiliary link. Additionally, the STA Information field may include one link identification (ID) for both the primary link and the auxiliary link of the reported AP.

In some implementations, one of more channels of the primary link and one or more channels of the auxiliary link may include contiguous channels or non-contiguous channels in a frequency domain.

In some implementations, a duration of a TXOP of the frame exchange over the auxiliary link may be limited by a duration of an OBSS TXOP over the primary link.

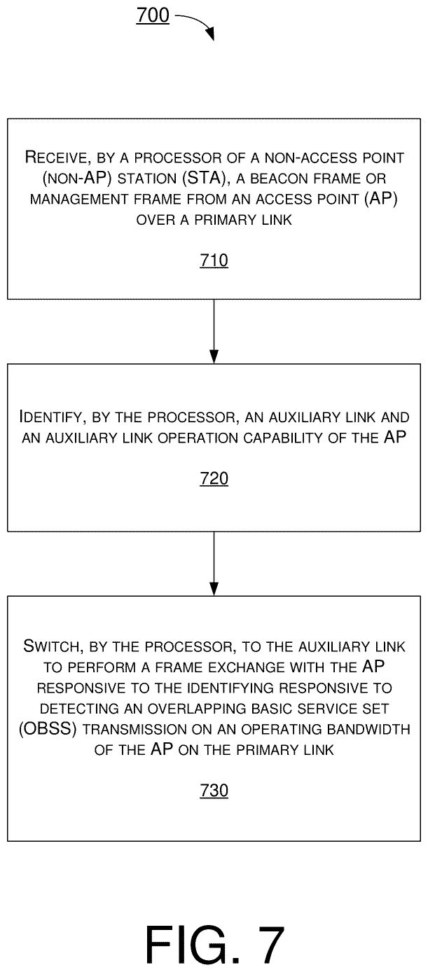

FIG. 7 illustrates an example process 700 in accordance with an implementation of the present disclosure. Process 700 may represent an aspect of implementing various proposed designs, concepts, schemes, systems, and methods described above. More specifically, process 700 may represent an aspect of the proposed concepts and schemes pertaining to non-primary channel access with a link management mechanism in wireless communications. Process 700 may include one or more operations, actions, or functions as illustrated by one or more of blocks 710, 720 and 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively, in a different order. Furthermore, one or more of the blocks/sub-blocks of process 700 may be executed repeatedly or iteratively. Process 700 may be implemented by or in apparatus 510 and apparatus 520 as well as any variations thereof. Solely for illustrative purposes and without limiting the scope, process 700 is described below in the context of apparatus 510 implemented in or as an AP STA (e.g., STA 110) and apparatus 520 implemented in or as a non-AP STA (e.g., STA 120) of a wireless network such as a WLAN in network environment 100 in accordance with one or more of IEEE 802.11 standards. Process 700 may begin at block 710.

At 710, process 700 may involve processor 522 of apparatus 520, as a non-AP STA (e.g., STA 120), receiving, via transceiver 526, a beacon frame or management frame from an AP (e.g., apparatus 510) over a primary link. Process 700 may proceed from 710 to 720.

At 720, process 700 may involve processor 522 identifying an auxiliary link and an auxiliary link operation capability of the AP. Process 700 may proceed from 720 to 730.

At 730, process 700 may involve processor 522 switching, via transceiver 526, to the auxiliary link to perform a frame exchange with the AP responsive to the identifying responsive to detecting an overlapping basic service set (OBSS) transmission on an operating bandwidth of the AP on the primary link.

In some implementations, in identifying, process 700 may involve processor 522 identifying the auxiliary link operation capability of the AP on the auxiliary link in an UHR Operation element or UHR Capability element carried in the beacon frame or management frame. In some implementations, the non-AP STA may be affiliated with a single-link device or a single-radio MLD.

In some implementations, in identifying, process 700 may involve processor 522 identifying the auxiliary link through an RNR element in the beacon frame or management frame with a TBTT Information Field Type subfield set to one predefined value (e.g., 1) and a TBTT Information Field Length subfield set to another predefined value (e.g., 1 or 3) in a TBTT Information field corresponding to the AP, as a reported AP, on the auxiliary link. In some implementations, the non-AP STA may be affiliated with a multi-radio MLD.

In some implementations, in identifying, process 700 may involve processor 522 determining an operating class and a channel number of the auxiliary link through an operating class subfield and a channel number subfield in a Neighbor AP field corresponding to the reported AP on the auxiliary link in an RNR element in the beacon frame or management frame.

In some implementations, in identifying, process 700 may further involve processor 522 identifying a primary channel of the AP by a Neighbor AP Information field in the RNR element.

In some implementations, process 700 may further involve processor 522 indicating to the AP whether or not the non-AP STA is capable of dynamic channel switching to the auxiliary link.

In some implementations, process 700 may further involve processor 522 indicating, by the processor, to the AP: (a) whether or not the non-AP STA support an auxiliary link operation through an UHR Operating element or an UHR Capability element; and (b) one or more auxiliary link operation parameters of the non-AP STA.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an access point (AP), a basic service set (BSS) with an operating bandwidth over a primary link;
switching, by the processor, to an auxiliary link responsive to detecting an overlapping basic service set (OBSS) transmission on the operating bandwidth of the primary link; and
performing, by the processor, a frame exchange with one or more non-AP stations (STAs) over the auxiliary link.

2. The method of claim 1, wherein the switching comprises transmitting a beacon frame or management frame on the primary link to advertise a capability of the AP to operate on the auxiliary link in an Ultra-High-Reliability (UHR) Operation element or UHR Capability element carried in the beacon frame or management frame.

3. The method of claim 2, wherein the switching further comprises advertising the auxiliary link through a Reduced Neighbor Report (RNR) element with a Target Beacon Transmission Time (TBTT) Information Field Type subfield set to a first predefined value and a TBTT Information Field Length subfield set to a second predefined value in a TBTT Information field corresponding to the AP, as a reported AP, on the auxiliary link.

4. The method of claim 3, wherein the TBTT Information field corresponding to the reported AP on the auxiliary link comprises at least one of an AP multi-link device (MLD) identification (ID) subfield, a link ID subfield, a link disablement subfield, an auxiliary link bandwidth subfield, and a trigger uplink (UL) only subfield.

5. The method of claim 4, wherein a value of bit in the trigger UL only subfield indicates whether enhanced distributed channel access (EDCA) channel contention on the auxiliary link by the one or more non-AP STAs is allowed.

6. The method of claim 5, wherein, responsive to the bit in the trigger UL only subfield being set to a predefined value, an uplink (UL) transmission on the auxiliary link is trigger-based and that no EDCA channel access is allowed.

7. The method of claim 4, wherein a value of bit in the link disablement subfield indicates whether the auxiliary link is enabled or disabled, and wherein:
responsive to the link disablement subfield indicating the auxiliary link being enabled, the reported AP is enabled to operate on the auxiliary link; and
responsive to the link disablement subfield indicating the auxiliary link being disabled, the reported AP is disabled to operate on the auxiliary link.

8. The method of claim 3, wherein an operating class and a channel number of the auxiliary link are indicated in a Neighbor AP field corresponding to the reported AP on the auxiliary link in the RNR element.

9. The method of claim 1, wherein the AP, as a reporting AP, is affiliated with an AP multi-link device (MLD), wherein an AP MLD identification (ID) corresponding to each of the primary link and the auxiliary link are set to a same value, and wherein a link ID corresponding to each of the primary link and the auxiliary link are set to another same value.

10. The method of claim 1, wherein the switching comprises a reporting AP affiliated with an AP multi-link device (MLD) transmitting a beacon frame or management frame with a Basic Multi-Link element corresponding to the AP, as a reported AP, which is also affiliated with the AP MLD, and wherein:
a STA Information field of a per-STA Profile subelement in the Basic Multi-Link element indicates an auxiliary link operation capability of the reported AP and one or more auxiliary link operating parameters;
the STA Information field also includes a BSS Parameters Change Count which is incremented responsive to a change related to the auxiliary link; and
the STA Information field includes one link identification (ID) for both the primary link and the auxiliary link of the reported AP.

11. The method of claim 1, wherein one of more channels of the primary link and one or more channels of the auxiliary link comprise contiguous channels or non-contiguous channels in a frequency domain, and wherein a duration of a transmission opportunity (TXOP) of the frame exchange over the auxiliary link is limited by a duration of an OBSS TXOP over the primary link.

12. A method, comprising:
receiving, by a processor of a non-access point (non-AP) station (STA), a beacon frame or management frame from an access point (AP) over a primary link;
identifying, by the processor, an auxiliary link and an auxiliary link operation capability of the AP; and
switching, by the processor, to the auxiliary link to perform a frame exchange with the AP responsive to the identifying responsive to detecting an overlapping basic service set (OBSS) transmission on an operating bandwidth of the AP on the primary link.

13. The method of claim 12, wherein the identifying comprises identifying the auxiliary link operation capability of the AP on the auxiliary link in an Ultra-High-Reliability (UHR) Operation element or UHR Capability element carried in the beacon frame or management frame.

14. The method of claim 13, wherein the non-AP STA is affiliated with a single-link device or a single-radio multi-link device (MLD).

15. The method of claim 12, wherein the identifying comprises identifying the auxiliary link through a Reduced Neighbor Report (RNR) element in the beacon frame or management frame with a Target Beacon Transmission Time (TBTT) Information Field Type subfield set to a first predefined value and a TBTT Information Field Length subfield set to a second predefined value in a TBTT Information field corresponding to the AP, as a reported AP, on the auxiliary link.

16. The method of claim 15, wherein the non-AP STA is affiliated with a multi-radio multi-link device (MLD).

17. The method of claim 12, wherein the identifying comprises determining an operating class and a channel number of the auxiliary link through an operating class subfield and a channel number subfield in a Neighbor AP field corresponding to the reported AP on the auxiliary link in a Reduced Neighbor Report (RNR) element in the beacon frame or management frame.

18. The method of claim 17, wherein the identifying further comprises identifying a primary channel of the AP by a Neighbor AP Information field in the RNR element.

19. The method of claim 12, further comprising:
indicating, by the processor, to the AP whether or not the non-AP STA is capable of dynamic channel switching to the auxiliary link.

20. The method of claim 12, further comprising:
indicating, by the processor, to the AP:
whether or not the non-AP STA support an auxiliary link operation through an Ultra-High-Reliability (UHR) Operating element or an UHR Capability element; and
one or more auxiliary link operation parameters of the non-AP STA.
